(19) United States
(12) Patent Application Publication
(10) Pub. No.: US 2013/0324223 A1
(43) Pub. Date: Dec. 5, 2013

(54) NON-CASH TRANSACTION SYSTEM FOR USE IN A GAMING/AMUSEMENT ENVIRONMENT

(71) Applicant: Craig K. Potts, Scottsdale, AZ (US)

(72) Inventor: Craig K. Potts, Scottsdale, AZ (US)

(21) Appl. No.: 13/906,099

(22) Filed: May 30, 2013

Related U.S. Application Data
(60) Provisional application No. 61/653,284, filed on May 30, 2012.

(51) Int. Cl. G07F 17/32

(52) U.S. Cl. CPC G07F 17/3246
USPC 463/25

(57) ABSTRACT

A system includes a receiver, a printer, and a corresponding controller to accommodate non-cash wagering while also providing a convenient process for use of currency and coins. As one function, the receiver accommodates the receipt and recognition of paper currency. The denomination of the paper currency is identified, and communicated to control circuitry so that it can be converted to point tokens. The printer will then generate a point token useable for play of the gaming device. Similarly, the system may have a coin receiver for receipt/identification of coins and the subsequent generation of corresponding point tokens. To accommodate play of the gaming machine, the receiver is capable of receiving and recognizing point tokens and applying credits on a related gaming machine. Once the point tokens are recognized and credits have been applied, the user can then proceed with the play of the gaming machine using the applied credits.

### BACKGROUND

Electronic gaming presents an exhilarating and exciting form of entertainment for the many different people. To meet the continuing demand for variety, many different gaming machines have been developed, providing many different playing opportunities and many different types of gaming scenarios. Generally speaking, each of these gaming machines presents an exciting wagering opportunity for players, and many different corresponding methods for winning different prizes.

Historically, the 3-wheel slot machine is one of the most recognized gaming machines, wherein the user places a wager and subsequently causes the wheels on the machine to rotate and randomly stop on particular numbers. The configuration of the displayed numbers will then dictate whether a winning configuration has been achieved and if a prize is awarded. Stated differently, a number of payout amounts have been previously established which correspond to various wheel combinations. The player is then awarded the appropriate prize amount depending upon the wheel combinations displayed. Since this original gaming machine was introduced, many subsequent gaming machines have been developed with much more complexity, including many different types of games, multiple wagering opportunities and many pay-out possibilities (e.g. different payout amounts, bonus winnings, bonus multipliers, etc.).

As is well known, gaming machines and electronic amusement devices are highly regulated industries. To provide further complications, each jurisdiction handles regulation differently. Consequently, gaming operators must deal with many different rules and regulations, depending upon the location where the machine is operated. In one such example, certain jurisdictions may not allow cash payouts from machines, or receipts to be printed which have cash amounts listed. These jurisdictions require different handling, such as printed receipts without amounts listed, or the conversion to credits or points. Not surprising, these requirements complicate the operation and handling of gaming machines. In order to make these machines more enjoyable and enticing for users, it is beneficial to satisfy these requirements while also making the machines convenient and user friendly.

An additional concern of many jurisdictions relates to the mechanisms used to handle paper currency. More specifically, some jurisdictions prohibit or discourage the use of bill handlers (aka bill validators) specifically integrated with gaming machines to accommodate wagering. Bill handlers are obviously convenient for players, thus it beneficial to provide alternative mechanisms for easily using paper currency while also meeting the requirements of the necessary regulations.

### SUMMARY

A wagering system is provided where only point tokens can be used for play of a wagering game and coins/currency are converted to point tokens before allowing play. The system has a receiver for receiving paper currency and/or coins, and paper point token certificates, and which is further capable of recognizing the denomination amount of the received items. When paper currency is received, the receiver communicates a corresponding denomination amount to a system controller so that a corresponding point token certificate can be created and printed. A similar process is followed when coins are received, thus corresponding point token certificates are generated when coins are received.

The receiver is further capable of receiving either the recently printed point tokens, and other point tokens generated by other devices, and subsequently communicating the point token values with the gaming machines. More specifically, the point tokens are read, and a signal is generated which communicates the value or amount of point tokens received. Based upon the point token values, a corresponding number of credits or wagering units are established for use in playing the gaming device. At this point, a user can proceed to play the gaming device as desired. In this manner, the gaming device does not respond directly to the input of coins or paper currency, but only responds to point token certificates. That said, the process of transitioning paper currency to point token certificates is easily accomplished using components coupled to or cooperating with the gamine device, and communicating with an overall gaming device controller.

### DESCRIPTION OF THE DRAWINGS

The various embodiments may be better understood with reference to the description below, in conjunction with the drawings, in which:

FIG. 1 is a schematic diagram of a embodiment of the system for handling paper currency;

FIG. 2 is a flowchart showing an example embodiment of the method for handling paper currency; and

FIG. 3 is a second flowchart illustrating a method for receipt of point tokens.

### DESCRIPTION OF THE EMBODIMENTS

To deal with those situations where the use of paper currency is discouraged, or where receipts having cash amounts or cash denominations printed thereon are not allowed by gaming regulators, the systems and devices utilized by the present embodiments operate according to a point allocation system. These systems award point tokens, and print these point token values on printed receipts. In certain cases, these “point tokens” correlate to a particular dollar value, however this is not required to achieve the same results. In use, the gaming devices and underlying systems allow users to participate in electronic games in the typical/normal way while also complying with related regulations. As one example, the gaming machine itself may accept coins as wagers, and then allow participation in the underlying game provided by that particular machine. During play, winning amounts are tacked as “credits” on the machine, thus allowing continued play without the interchange of currency or coins at each instance. This continues until the credits on the machine are reduced to zero, or the player wishes to stop playing that particular machine. If credits remain on the machine, the player will then cash out of the machine.

The typical methodology for cashing out (or pay-outs) involves advancing appropriate cash amounts (i.e. coins) or printing redeemable receipt with a cash value printable thereon. In use, the player will then simply present the printed receipt to a teller and receive cash as winnings. Alternatively, the receipt can be introduced into related gaming machines and credits will thus be provided based upon the amount printed on the receipt. Certain jurisdictions however prohibit the printing of dollar amounts upon receipts. This presents a complication for the operators and the gaming devices.

To provide convenient operation in jurisdictions where cash values cannot be printed on receipts, the systems and devices of the present embodiment operate on the above-mentioned point tokens system. More specifically, gaming receipts will include a printed point token, value or amount, which may correspond to winning values in some way. In some cases, each point may be worth one penny. In other cases, points may be worth some differing value involving a computation of some type. Most importantly however, points are printed and/or assigned to the point token, as opposed to any particular dollar amount. Although conversions can be calculated, the printed receipt itself will not provide any such indication. Consequently, the receipt does not necessarily provide the same “value”, and satisfies regulators requirements.

In addition to the issues discussed above related to receipts with cash values printed thereon, certain jurisdictions disfavor bill acceptors and the direct ability to insert paper currency into the gaming machines. The above-mentioned point tokens methodology is also capable of addressing these issues.

Producing receipts with point values can provide an alternative method for effectively using a bill validator. In operation, the bill validator will receive currency, and produce a printed point token which has an incorporated point value for the particular gaming institution involved. The player can then take this printed point token and insert it into a gaming machine as desired. Once inserted, appropriate “credits” will be denoted on the machine and subsequent game play can proceed.

As can be appreciated, the generation and use of a printed receipt in a bill validator produces a “2-step” process when paper currency is utilized. Certain regulators favor this 2-step process as one method of insuring sensible gaming receipts. It is noted that the same bill validator could be utilized in a particular machine to achieve this 2-step process. In use, a player will simply insert currency into the bill validator and receive a printed receipt having the point value printed thereon. To continue play of the gaming machine, the player will simply reinsert the printed receipt and receive appropriate credits. In this configuration, gaming machines themselves will not accept currency and will only respond to the printed receipts.

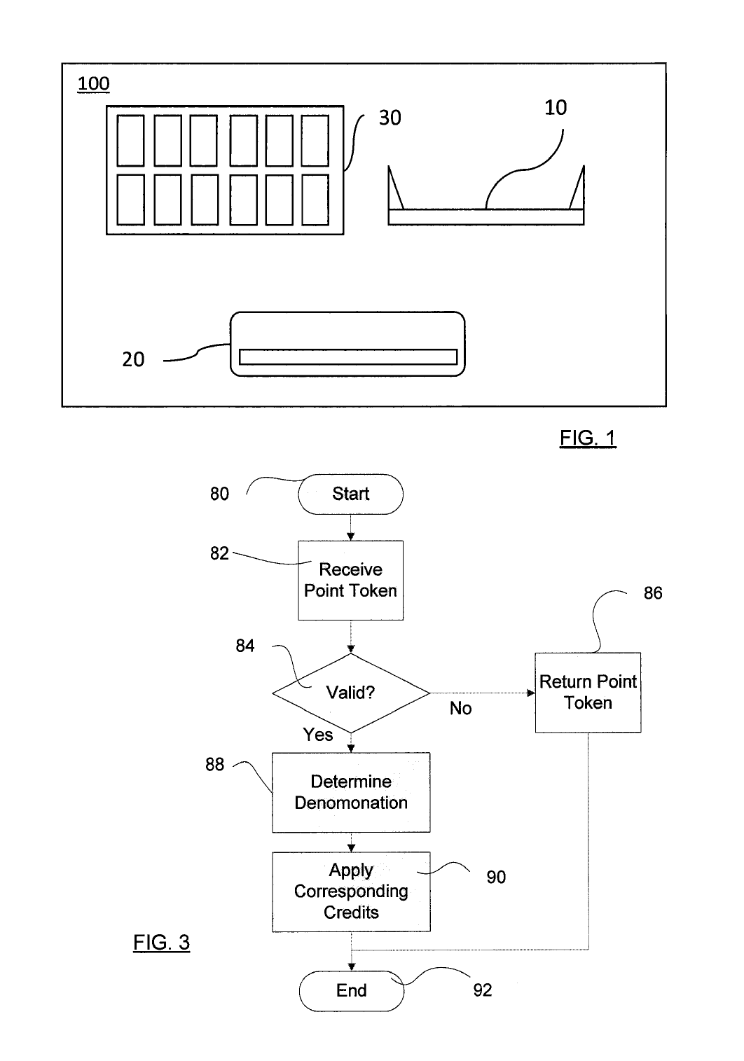

Referring now to FIG. 1, an example is shown of the basic components making up the system 100 contemplated for handling of paper currency. As shown, the device includes a bill validator 10, which is designed to receive and recognize paper currency. Also included is a printer 20 capable of producing the above mentioned point tokens. Lastly, system 100 includes a basic display 30 for presenting messages to the user. In operation, the user will insert paper currency into bill validator 10. The internal circuitry (not shown) will then recognize the amounts inserted and coordinate the printing of an appropriate point token. The internal circuitry may include a processor, controller, microcontroller, or specialized circuit designed to carry out the conversion process from currency/coins to point tokens. The printing will obviously utilize printer 20.

System 100 could be configured as a stand-alone device, or could be incorporated into a gaming machine to provide further benefits. When so incorporated into a gaming machine, the bill validator 10 will also be capable of receiving and recognizing printed point tokens. When these point tokens are inserted, the internal circuitry of system 100 will communicate with the gaming machine itself to provide the appropriate number of credits for subsequent game play. The player may then proceed to play the games provided on the related gaming machine. Those skilled in the art will recognize that this process is applicable to many different types of gaming machines. Upon the completion of play, printer 20 will similarly be able to again print point tokens as appropriate, depending upon outcomes of the games themselves.

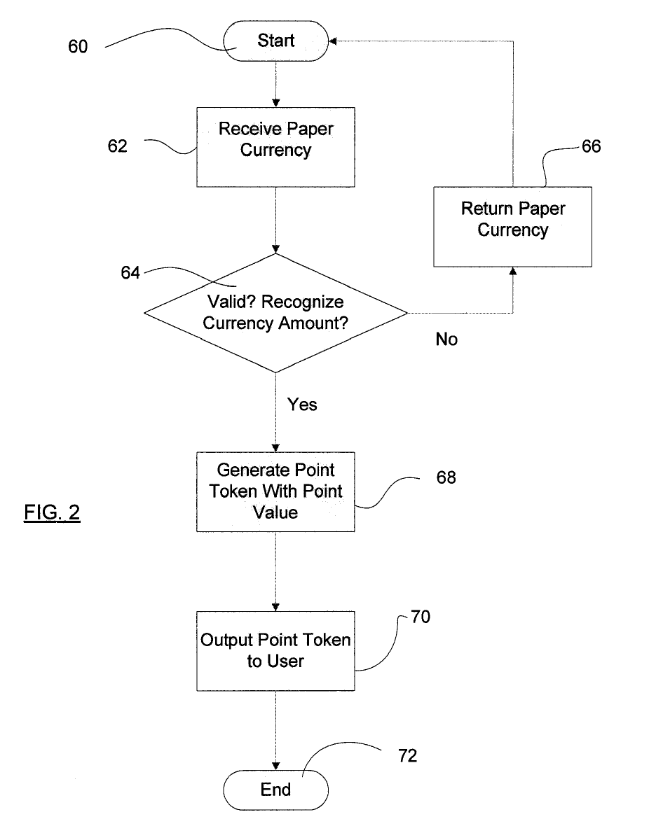

FIGS. 2 & 3 illustrate the additional processes carried out in the preferred embodiment for non-cash wagering. Generally speaking, FIG. 2 illustrates the process of receiving paper currency, and the related production of point tokens. Similarly, FIG. 3 illustrates the process of using point tokens to start game play in the gaming device. Naturally, alternative processes could be possible.

Referring now to FIG. 2, the process of handling paper currency is typically in idle at a start point 60 until paper currency in introduced. At a receive step 62, the paper currency is received by a receiver 10, and subsequently analyzed at step 64. If the paper currency is valid, and the denomination can be recognized, the process will move to step 68 where the corresponding point token is generated. If the paper currency is not valid, or the denomination is not recognized, the process will move to step 66 where the provided paper currency is returned to the user. Again, if the paper currency is valid, the point token is output to the user at step 70, and the process ends at step 72. At this point, the point token can now be used by the user as desired in a corresponding gaming machine, or any other device having a corresponding capabilities to utilize point tokens. In the anticipated embodiment, the point token will again not include a printed dollar amount value, only a point value.

It will be recognized that the above process could also be used for coins. In that application, a coin receiver is used, and the related point token will simply have an amount corresponding to the value of the coins provided. This feature may be particularly valuable in those areas where coins are more prevalent than paper currency.

With point tokens in hand, an user can then proceed to participate in gaming activities. In these situations, the point tokens are used to generate credits in the desired gaming machines, and appropriate wagering can then occur. One example embodiment of this process is better illustrated in FIG. 3, wherein credits are established using point tokens. This process sits essentially idle at step 80, until a point token is introduced into a receiver. At this time, the process will progress to step 82, where the point token is received. The point token is then analyzed at step 84 to determine its validity. Using appropriate indicators on the point token, the validity can be determined. In some embodiments, these indicators may include embedded codes, special markings, or other security/validity measures. If invalid, the point token is returned at step 86, and the process ends. If it is determined that the point token is valid, the process moves to step 88 where the denomination is determined. At this point, the process will apply the appropriate credits to the gaming machine at step 90, and the user may continue to play whatever games are supported by the particular gaming machine.

While the discussion above has related to the use of point tokens in the context of a video gaming machine, it will be understood that these same principles could be used in many different types of electronic wagering devices. Some examples include of alternative devices include electronic card machines (e.g. video poker or blackjack), pull tab machines, bingo machines, automated wagering machines used in horse or dog racing, paramutal machines of all types (e.g. sports wagering), etc.

Although certain embodiments of the inventive concepts have been described above, it will be understood that modifications and changes can be made without departing from the scope and spirit of the described invention. For example, point tokens could be used to designate any type of currency, prize value or other thing of value. In addition, certain devices could be integrated into a single product, or could be used as stand alone devices with appropriate communication connections there between.

What is claimed is:

1. A gaming system configured to accommodate non-cash wagering, comprising:
a gaming device hosting a wagering game;
a controller cooperating with the gaming device to carry out wagering functions;
a receiver capable of accepting paper currency of a denominated amount, the receiver further capable of recognizing the denominated amount of the paper currency and communicating the recognized amount to the controller; and
a printer coupled to the controller, the controller capable of instructing the printer to print a point token for a determined point token amount, the determined point token amount correlated to the denominated amount of the paper currency;
wherein the receiver is further capable of accepting the point token and communicating the point token amount to the controller thereby allowing the controller to provide credits and thus enable play of the wagering game, the receiver further capable of receiving alternative point token certificates generated from a device other than the printer.

2. The gaming system of claim 1 wherein each point of the point token amount corresponds to one dollar received by the receiving device.

3. The gaming system of claim 1 wherein the credits communicated to the gaming device for play of the wagering game are subsequently stored as part of the play of the wagering game.

4. The gaming system of claim 1 further comprising a coin acceptor capable of receiving coins and recognizing the demonated amount of the received coins, the coin acceptor coupled to the controller for communicating the denominated amount such that point tokens can be generated corresponding to the overall amount of the received coins.

5. The gaming system of claim 1 wherein each point of the point token amount corresponds to one cent received by the receiving device.

6. A method coordinated by a controller for accommodating game play on a wagering game device while not directly accepting paper currency to support game play, the method comprising:
providing a receiver for receiving paper currency and determining the denomination amount thereof, the receiver further communicating the denomination amount to the controller;
the controller instructing a printer to print a point token having a point token amount correlated to the denomination amount determined by the receiver;
receiving the point token in the receiver, wherein the point token amount is recognized by the receiver and communicated to the controller; and
the controller awarding credits for the play of the wagering game based upon the point token amount, and thus coordinating play of the wagering game.

7. The method of claim 6 wherein the denomination of the paper currency is in dollars, and the point token amount is correlated to the number of dollars provided.

8. The method of claim 7 wherein each point listed on the point token is one cent.

9. The method of claim 6 wherein the printing of the point token and the subsequent receipt in the receiver can occur on two separate wagering game devices.

10. The method of claim 6 wherein the method further includes the receipt of coins and the printing of point tokens having a point token amount correlated to the value of the received coins.

11. A multi-unit gaming system configured to accommodate non-cash wagering, comprising:
a plurality of gaming devices, each hosting a wagering game, wherein each gaming device further comprises;
a controller cooperating with the gaming device to carry out wagering functions;
a receiver capable of accepting paper currency of a denominated amount, the receiver further capable of recognizing the denominated amount of the paper currency and communicating the recognized amount to the controller; and
a printer coupled to the controller, the controller capable of instructing the printer to print a point token for a determined point token amount, the determined point token amount correlated to the denominated amount of the paper currency;
wherein the receiver is further capable of accepting the point token produced by the printer of any of the plurality of gaming devices and communicating the point token amount to the cooperating controller thereby allowing the controller to provide credits on the gaming device and thus enabling play of the wagering game.

12. The gaming system of claim 11 wherein each point of the point token amount corresponds to one dollar received by the receiving device.

13. The gaming system of claim 11 wherein each point of the point token amount corresponds to one cent received by the receiving device.
